(19) United States
(12) Patent Application Publication
(10) Pub. No.: US 2001/0012381 A1
(43) Pub. Date: Aug. 9, 2001

(54) VISION-BASED, ON-LOOM FABRIC INSPECTION SYSTEM

(76) Inventors: HAMED SARI-SARRAF, KNOXVILLE, TN (US); JAMES S. GODDARD JR., CLINTON, TN (US); EARL W. WALKER JR., MEMPHIS, TN (US)

Correspondence Address: J KENNETH DAVIS, LOCKHEED MARTIN ENERGY, RESEARCH CORPORATION, P O BOX 2009, OAK RIDGE, TN, 378318243

(21) Appl. No.: 08/938,121

(22) Filed: Sep. 26, 1997

(51) Int. Cl. G06K 9/00

(52) U.S. Cl. 382/111

(57) ABSTRACT

In a vision-based on-loom fabric inspection system, high quality images of the fabric under construction are processed using a line-scan camera and PC platform with an algorithm based on the wavelet transformation and the correlation dimension to detect and map defects in the fabric.

The United States Government has rights in this invention pursuant to contract no. DE-AC05-84OR21400 between the United States Department of Energy and Lockheed Martin Energy Systems, Inc., and pursuant to contract no. DE-AC05-96OR 22464 between the United States Department of Energy and Lockheed Martin Energy Research Corporation.

### FIELD OF THE INVENTION

The present invention relates to apparatus and methods for performing quality inspections of fabric as the fabric is manufactured on a loom or machine for weaving fabric, and more particularly to vision-based apparatus and methods for on-loom inspection of fabric.

### BACKGROUND OF THE INVENTION

In the production of fabrics, quality control is of concern. In order to more precisely control quality, it is first necessary to monitor quality as the fabric is produced so that corrections can be made immediately, thus minimizing the amount of off-quality fabric.

It is also desirable to provide a map of the fabric as it is produced, in order that the user of the fabric may know ahead-of-time where faults, flaws, or defects in a lot of fabric are located and may thus avoid investing additional materials and labor in off-quality goods which might be inadvertently produced using off-quality fabric.

Currently, much of the fabric inspection is done manually, and even with the most highly trained inspectors, it is estimated that only about 70% of the defects are detected. Thus, there is a growing realization that automated fabric inspection capability is needed in the textile industry.

Higher production speeds make the timely detection of fabric defects more important than ever. Newer weaving technologies also tend to include larger roll sizes and this translates into greater potential for off-quality production before inspection. Many segments of the industry are working towards just-in-time delivery and a poor quality production run can be disastrous. Presently, the inspection is done manually after a significant amount of fabric is produced, removed from the weaving machines or looms, combined into large rolls of 1000 to 2000 yards or more, and then sent to an inspection station. An optimal solution would be to automatically inspect fabric as it is being produced, and thus to alert maintenance personnel when the machine needs attention, to prevent production of defects, to change process parameters automatically, and thereby to improve product quality. Reducing the number of defects produced by timely maintenance or control would result in obvious savings. Also if inspection is accomplished on the machine, the need for 100% manual inspection is eliminated. Costs to inspect fabric manually range from 1.0 to 1.5 cents per yard. The cost to inspect the annual production of a machine would be $1,250 to $1,900. Other tangible and intangible benefits could be realized. Computer vision systems do not suffer from some human limitations such as inattention and exhaustion and thus provide robust detection with few false alarms.

A wide variety of defects are represented. Some defects are a direct cause of machine malfunction while others are from faulty yarns. Only a few of the defects known in the art are herein described. Some yarn defects relate to the filler yarn, commonly referred to as the pick yarn or pick; and other yarn defects relate to the warp yarn, commonly referred to as the end yarn or end. Other defects include start marks which are uneven areas normally resulting from stopping and restarting the loom and slubs which are nonuniformities due to an inclusion of foreign material such as lint into the fabric. For air jet looms, the defects are predominantly broken picks and slubs. Projectile looms produce defects such as broken ends and start marks. Both type looms suffer from machine faults as well as yarn faults that result in a variety of weaving defects.

Recently apparatus and methods for on-loom inspection of fabric have been developed which utilize wavelet transform techniques and fuzzy inferencing methods. One such system, has been developed by scientists at Georgia Tech. The resulting arrangement is called Fuzzy Wavelet Analysis (FWA) and entails attributes described as an “intelligent” paradigm. The algorithms provide the ability to analyze image or target signatures in space/frequency localized manner while accommodating uncertainty. The FWA, as an intelligent paradigm, provides on-line adaptability and robust pattern classification through learning.

In the FWA method, the data from the 2-dimensional textile images is converted to a one-dimensional data stream by using fractal scanning and a primary classification of point, line, or area is made at this stage. Fault features are extracted from this data using a wavelet transform. These features are then fuzzified using a fuzzification algorithm that incorporates dynamic noise rejection. The fault features are fed to a fuzzy inferencing mechanism which compares them with the templates stored in the rulebase. Based on this inferencing, a declaration about the defect is made. The procedure can be applied, in principle, to only 1-dimensional data streams. However, it is just as applicable to 2-dimensional images with a specialized scanning technique known as fractal scanning. This scanning tool converts the 2-dimensional image into a 1-dimensional stream, but unlike conventional scanning mechanisms, it retains the neighborhood relationship of the 2-dimensional data. However, this method uses a conventional camera and lens which must scan the fabric to cover an area.

### OBJECTS OF THE INVENTION

Accordingly, it is an object of the present invention to provide a new and improved apparatus for automatic, on-loom, real-time inspection of fabric.

It is another object of the present invention to provide new and improved methods for automatic, on-loom, real-time inspection of fabric.

Further and other objects of the present invention will become apparent from the description contained herein.

### SUMMARY OF THE INVENTION

In accordance with one aspect of the present invention, the foregoing and other objects are achieved by an apparatus for on-loom inspection of fabric comprising: a camera means for acquiring image data which represents a linear image of the fabric as the fabric is being manufactured on a loom, the linear image being oriented generally in the plane of the fabric and generally perpendicular to the direction of the fabric's travel on the loom; a synchronizer means for synchronizing the travel of the fabric and the acquisition of image data, the synchronizer means being connected to the data acquisition means and disposed to synchronize data acquisition with the fabric's travel on the loom; an encoder means for encoding the image data to relate the image data to its position on the fabric to provide synchronized, encoded image data, the encoder means being communicably connected to the camera means and disposed to correlate image data with the image's position on the fabric as the fabric travels on the loom; and, a DSP-based processor means, the DSP processor means being operable in communication with a PC platform, and being communicably connected to the encoder means and camera means, and being suitably configured to perform image acquisition control and fabric image analysis in cooperation with the PC platform.

In accordance with a second aspect of the present invention, the foregoing and other objects are achieved by a method for on-loom inspection of fabric comprising the steps of: acquiring image data which represents a linear image of the fabric as the fabric is being manufactured on a loom, the linear image being oriented generally in the plane of the fabric and generally perpendicular to the direction of the fabric's travel on the loom; synchronizing the travel of the fabric and the acquisition of image data and encoding the image data to relate the image data to its position on the fabric to provide synchronized, encoded image data; and processing the synchronized encoded image data through a DSP-based processor means communicably connected to a PC platform to perform image acquisition control and fabric image analysis.

### BRIEF DESCRIPTION OF THE DRAWINGS

In the drawings:

FIG. 1 is a schematic diagram of a vision-based, on-loom fabric inspection system.

FIG. 2 is a schematic diagram of the image analysis algorithm.

FIGS. 3a through 3f show outputs of the image analysis algorithm for the detection of a pick defect.

FIGS. 4a through 4f show outputs of the image analysis algorithm for the detection of a different pick defect on a different weave type than that in FIG. 3.

FIGS. 5a through 5f show outputs of the image analysis algorithm for the detection of a warp defect.

FIGS. 6a through 6e show outputs of the image analysis algorithm for the detection of a slub defect.

For a better understanding of the present invention, together with other and further objects, advantages and capabilities thereof, reference is made to the following disclosure and appended claims in connection with the above-described drawings.

### DETAILED DESCRIPTION OF THE INVENTION

The present invention is both apparatus and methods which provide an automated defect detection and identification system which enhances the product quality and results in improved productivity to meet both customer demands and to reduce the costs associated with off-quality. It also provides a robust method to detect weaving defects

In the present invention, the improved system herein described provides a vision-based real-time, on-loom inspection of the fabric implemented on a relatively inexpensive PC platform and a line-scan camera and lens. This has never been accomplished in the past. This system overcomes those inherent problems that exist in the current approaches to fabric inspection, i.e., human inspectors or off-line inspections. Specifically, first it operates on-line to minimize defect-related costs, and to facilitate process control. Second, it produces high quality images of the fabric, as well as the defects for processing and archiving. Third, it achieves high detection rates while keeping the false alarm rates to a minimum. Fourth, it generates accurate defect parameters with consistency. Fifth, it offers an architecture that is open and expandable. Sixth, it is relatively inexpensive.

The vision-based fabric inspection system of the present invention accomplishes on-loom inspection of the fabric under construction with 100% coverage in real time. The inspection system, which offers an expandable, open architecture, can be manufactured at relatively low cost to the end user. Currently, no known system provides these capabilities. The system herein described, while synchronized to the motion of the web, acquires very high quality images of the fabric under construction using either front or back lighting. Then, an algorithm based on the wavelet transform and the correlation dimension is utilized to process the acquired images as they become available. It is during this processing that the system decides whether or not a portion of the fabric contains one or more defects. This determination is made by comparing the pertinent attribute(s) of the fabric under inspection with that which is learned from a reference fabric. Defects are then localized with a high degree of accuracy, and characterized through the extraction of their pertinent features. The system is capable of making these features available for further analysis and archiving. Image acquisition, analysis, and reporting are performed entirely on a PC platform equipped with an off-the-shelf, DSP-based board. The inspection system has been subjected to hours of testing under real-life conditions, and has performed superbly.

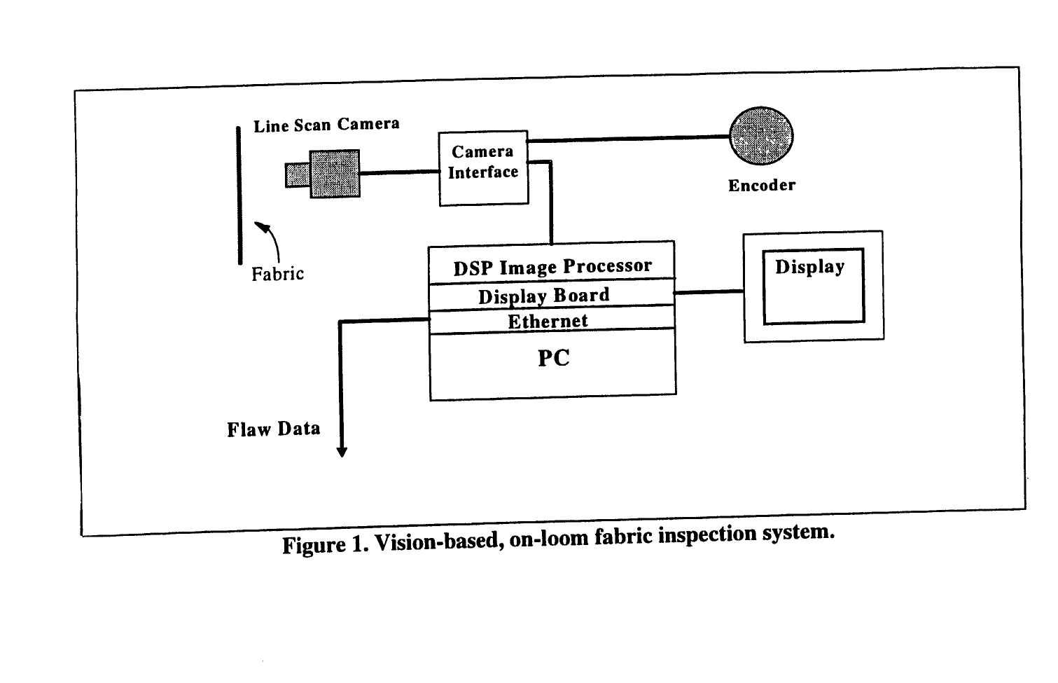

The system, shown in block diagram form in FIG. 1, is described in the functional terms of image acquisition on the moving fabric; fabric image analysis for detection, localization, and characterization; and real-time processing on a PC platform to facilitate 100% inspection.

### Hardware Requirements

Hardware components include: a line-scan camera and lens, illumination for front- and back-lit configurations, encoder, encoder/camera interface for synchronization of web motion to image acquisition, and a DSP-based processor operating on a PC platform for image acquisition control and for performing fabric image analysis.

### Image Acquisition

The line-scan camera acquires images one line at a time at the required resolution. The line is perpendicular to the direction of fabric motion. After the fabric moves the required distance, another line is acquired. A complete image is then built up and queued for image analysis. Continuous, 100% inspection is possible since image acquisition is performed in parallel with image analysis. The encoder provides a pulse waveform in quadrature so that both forward and backward motion can be monitored. Due to a significant amount of mechanical vibration, inherent to the weaving process, the fabric motion is highly irregular, moving both forward and backward. The encoder/camera interface filters this motion to provide an output signal which is consistent with the true forward motion of the fabric. An integration time control for the camera produces high quality images of uniform intensity even with wide differences in the time between scan lines. Pixel to pixel non-uniformity correction is then applied by the DSP software to provide a uniform image.

### Image Analysis

The developed algorithm for image analysis processes the acquired 2-dimensional images of fabric as they become available. The algorithm, which is based on the wavelet transform and the correlation dimension, performs three crucial tasks on each image, namely defect detection, localization, and characterization.

The basis for defect detection in this approach is to compare the pertinent attribute(s) of the fabric under inspection with that which is learned from a reference fabric. Prior to this comparison, however, each fabric image is subjected to a decomposition, i.e., via the wavelet transform, followed by a recombination, i.e., via the edge data fusion. This sequence of events helps to accentuate the defects in the field of view while reducing the adverse effects of such perturbations as the underlying structure of the fabric, random noise, and non-uniform illumination. Following this procedure, each fabric image is compared to a reference fabric image in terms of a measure which is based on a local application of the correlation dimension. It is this comparison that flags the inspection system either to continue with defect analysis or to declare the portion of the fabric under inspection “good” and to proceed with the next acquired image. As a consequence of the local application of the correlation dimension, the inspection system is capable of achieving defect localization accurately. It is from these localized portions of the fabric images that the pertinent features of the detected defects are extracted. Features such as centroid, length, and width can be reported for classification, process control, and archiving.

### Example Outputs of the Image Analysis System

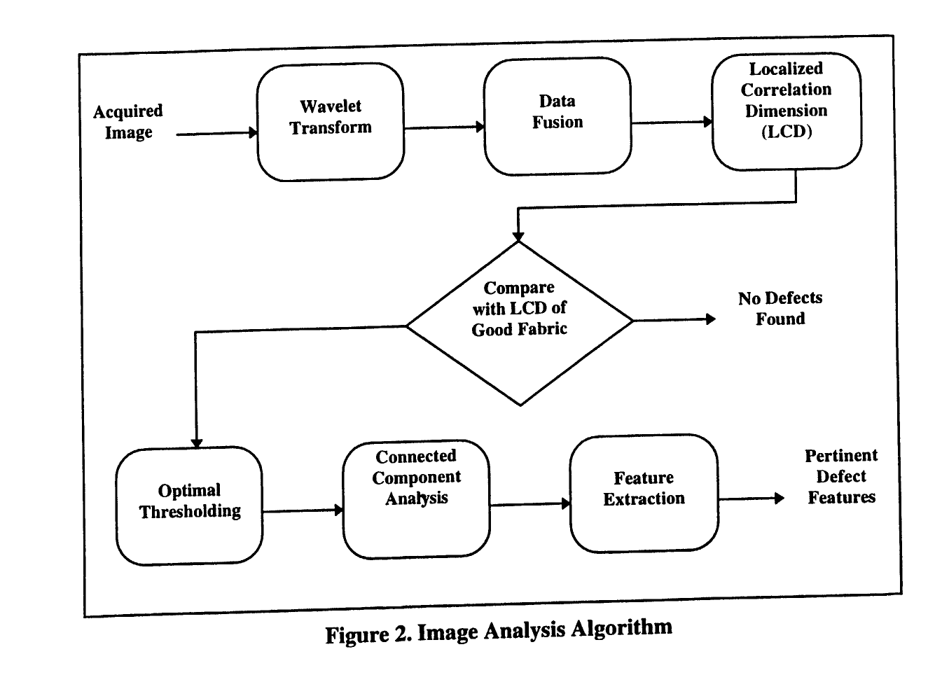

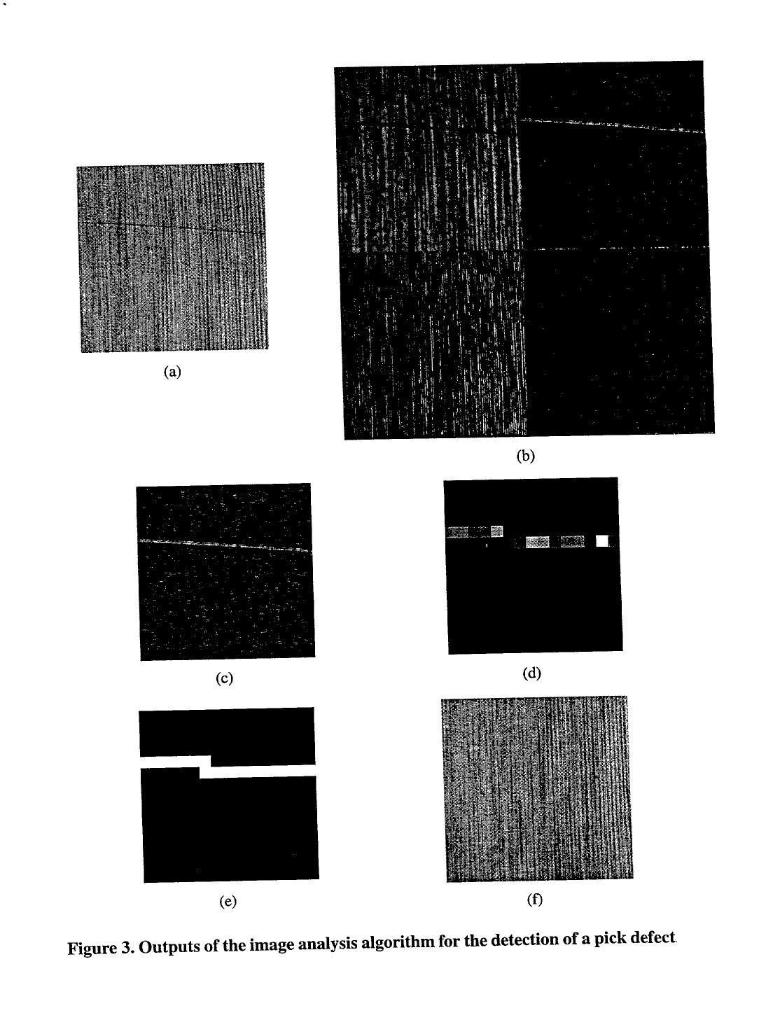

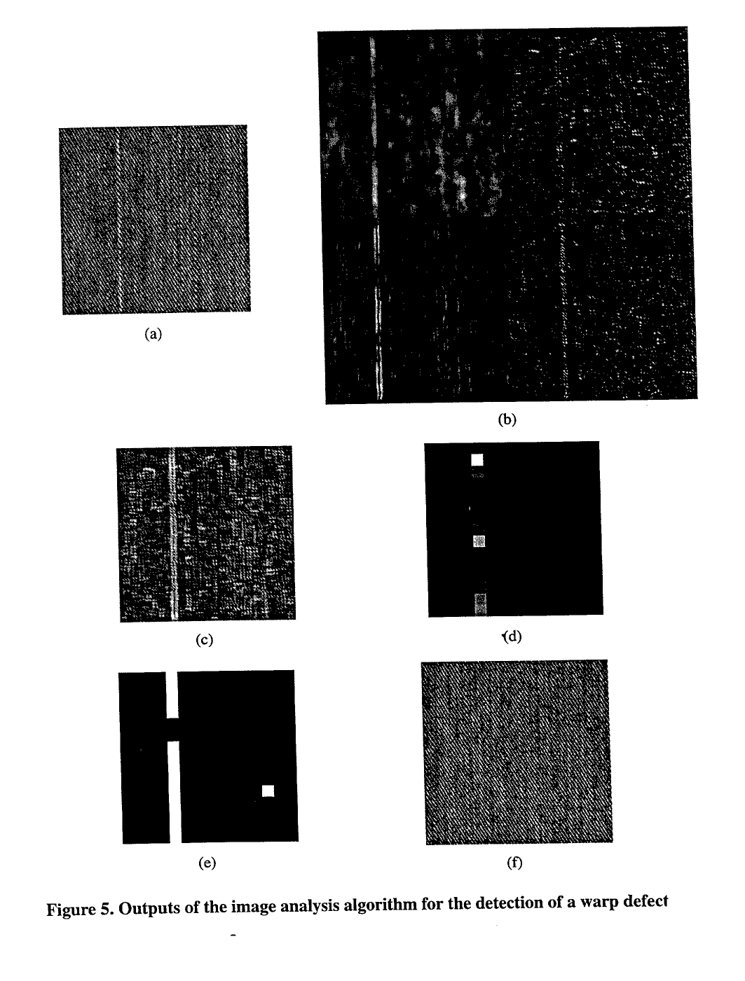

The images shown in FIGS. 3-6 demonstrate the efficacy of the previously described image analysis algorithm. The different images in each figure are the outputs of the different modules that make up the analysis algorithm described in FIG. 2. Each of FIGS. 3a, 4a, 5a, and 6a show the input image of the fabric under inspection. Each of FIGS. 3b, 4b, 5b, and 6b show the output of the wavelet transform module described in FIG. 2. The output of the data fusion module is shown in FIGS. 3c, 4c, 5c, and 6c. Data fusion refers to the generation of a single image out of the three edge images, i.e., upper and lower right and lower left images shown in FIGS. 3b, 4b, 5b, and 6b. This is accomplished by first measuring the total energy of each of the three images followed by normalization, and second, fusing these images pixel-by-pixel according to the equation:

I_{fused}(x,y)=(I₁(x,y)+I₂(x,y)+I₃(x,y))− ((I₁(x,y)*I₂(x,y))+I₁(x,y)*I₃(x,y))+(I₂(x,y)*I₃(x,y))

Each of the three terms on the right hand side of the above equation is included only if the corresponding energy value is less than a pre-specified threshold value. The localized correlation dimension module produces two outputs: one, a numerical output, i.e., the global homogeneity, which is used to decide whether or not a defect is present in the field of view; and two, an image of the local roughness measurement, which is shown in FIGS. 3d, 4d, 5d, and 6d. The image in each of FIGS. 3e, 4e, 5e, and 6e is the output of optimal thresholding module, and finally, the image in FIGS. 3f, 4f, and 5f is the image of the reference, or defect-free, fabric. If this number is sufficiently larger than the reference value (there is usually an order of magnitude difference), the fabric under consideration is said to contain a defect. For example, the global homogeneity measurement for the image in FIG. 3f was 1.1, whereas the same measurement produced a value of 58.1 for the image in FIG. 3a. Steps beyond those presented in these figures, i.e., connected component analysis and feature extraction, can be implemented using widely available algorithms within the computer vision art.

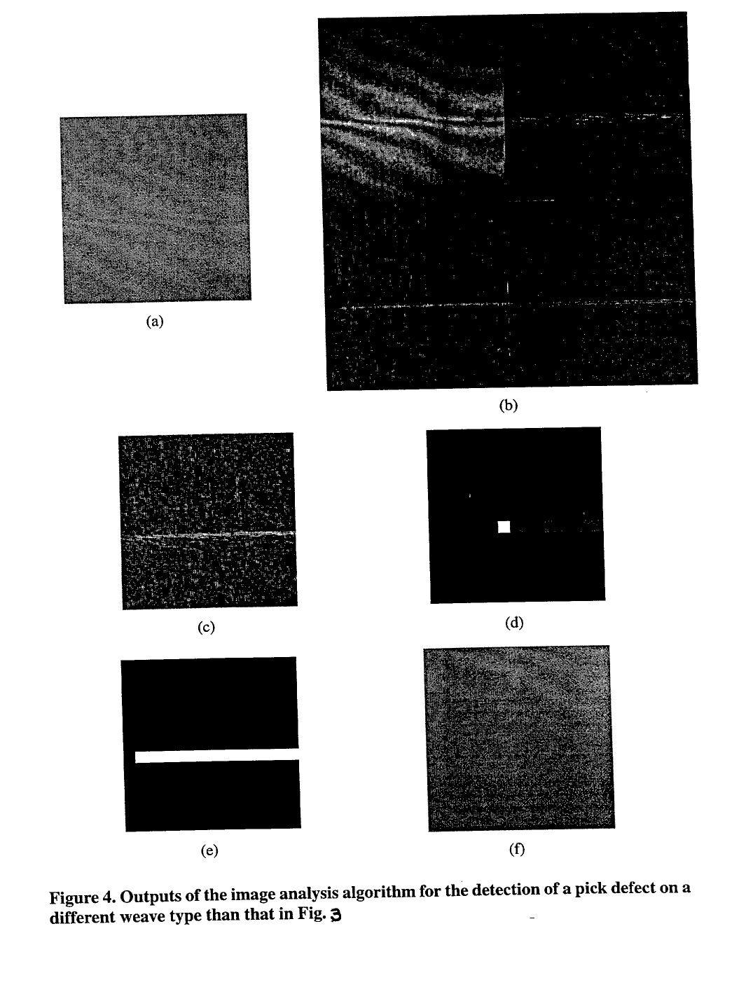

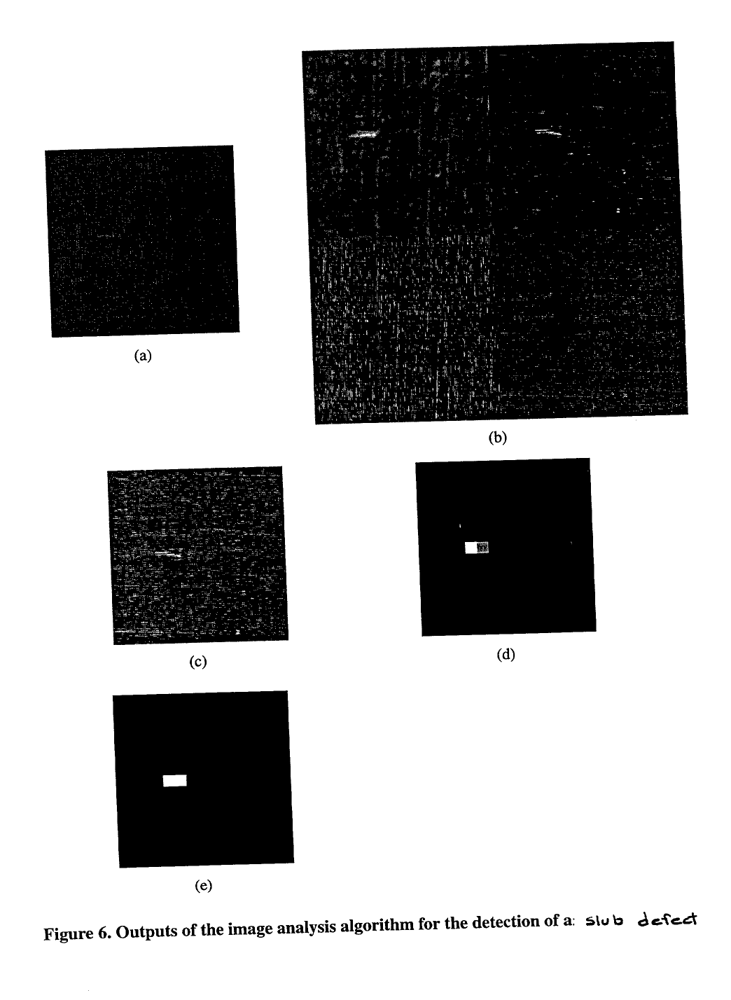

The images in FIGS. 3a-6c also point to the robustness of the algorithm under varying conditions. The images in FIGS. 3 and 4 demonstrate the detection of the same type defect on fabrics with different weave types. Also, the image in FIG. 6a was acquired with front-lighting, wherein the light source and camera are disposed on the same side of the fabric, in contrast to the rest of the images, which were obtained using back-lighting.

### Real-Time Processing

Real-time processing allows the processing of one fabric image during the period of time the next image is being obtained and requires the coordinated efforts of the PC and the DSP. The DSP provides for the image acquisition and for the detection and localization of defects. The PC provides the operator interface and serves to supervise the actions of the DSP.

### Operation

The sequence begins when an operator starts the inspection system. The PC initiates the image acquisition on the DSP. When the image has been acquired, the DSP signals the PC. The PC then initiates the next image acquisition into a separate region of DSP memory and initiates the image analysis algorithm. The algorithm processes the previously acquired image as described above, reporting the number of defects detected and their respective features such as centroid, length, and width. The data returned to the PC can then be used for display, archiving, making decisions about the quality of the fabric, or process control. After the image analysis algorithm has completed its processing, the PC waits for the current image acquisition to be completed before initiating the next acquisition. By maintaining two image buffers, one for the current image being acquired and one for the image previously acquired and currently being processed, the system can achieve real-time processing with 100% coverage.

The PC provides the operator interface allowing the operator to control the system. The operator can initiate acquisition, start detection, stop the system, and analyze previously acquired images. By varying the parameters of the algorithm, the operator can adjust the detection to fit a specific need. The parameters are made readily available for adjustment.

While there has been shown and described what are at present considered the preferred embodiments of the invention, it will be obvious to those skilled in the art that various changes and modifications can be made therein without departing from the scope of the inventions defined by the appended claims.

What is claimed is:

1. Apparatus for on-loom inspection of fabric comprising:
A. camera means for acquiring image data which represents a linear image of the fabric as the fabric is being manufactured on a loom, the linear image being oriented generally in the plane of the fabric and generally perpendicular to the direction of the fabric's travel on the loom;
B. synchronizer means for synchronizing the travel of the fabric and the acquisition of image data, the synchronizer means being connected to the data acquisition means and disposed to synchronize data acquisition with the fabric's travel on the loom.
C. encoder means for encoding the image data to relate the image data to its position on the fabric to provide synchronized, encoded image data, the encoder means being communicably connected to the camera means and disposed to correlate image data with the image's position on the fabric as the fabric travels on the loom; and,
D. DSP-based processor means, the DSP processor means being operable in communication with a PC platform, and being communicably connected to the encoder means and camera means, and being suitably configured to perform image acquisition control and fabric image analysis in cooperation with the PC platform.

2. The apparatus described claim 1 wherein the camera means comprises a line-scan camera and lens.

3. The apparatus described in claim 1 wherein the DSP-based processor means utilizes the wavelet transformation to perform fabric image analysis in cooperation with the PC platform.

4. The apparatus described in claim 1 wherein the DSP-based processor means utilizes the correlation dimension to perform fabric image analysis in cooperation with the PC platform.

5. The apparatus described in claim 1 further comprising illumination means for illuminating the fabric at the area where the linear image in being acquired by the camera means.

6. A method for on-loom inspection of fabric comprising the steps of:
A. acquiring image data which represents a linear image of the fabric as the fabric is being manufactured on a loom, the linear image being oriented generally in the plane of the fabric and generally perpendicular to the direction of the fabric's travel on the loom;
B. synchronizing the travel of the fabric and the acquisition of image data and encoding the image data to relate the image data to its position on the fabric to provide synchronized, encoded image data;
C. processing the synchronized encoded image data through a DSP-based processor means communicably connected to a PC platform to perform image acquisition control and fabric image analysis.

7. The method as described in claim 6 wherein the image data is acquired using a line-scan camera and lens.

8. The method as described in claim 6 wherein the DSP-based processor means utilizes the wavelet transformation to perform fabric image analysis in cooperation with the PC platform.

9. The method as described in claim 6 wherein the DSP-based processor means utilizes the correlation dimension to perform fabric image analysis in cooperation with the PC platform.

10. The method as described in claim 6 further comprising the step of providing illumination of the fabric at the area where the linear image is being acquired by the camera means.

11. The method as described in claim 10 wherein the fabric is illuminated from the same side of the fabric that the camera means is located on.

12. The method as described in claim 10 wherein the fabric is illuminated from the opposite side of the fabric that the camera means is located on.
